(19) United States
(12) Patent Application Publication
(10) Pub. No.: US 2016/0362005 A1
(43) Pub. Date: Dec. 15, 2016

(54) Capturing, Re-using and Redirecting Lost Energy due to Dynamic Braking

(71) Applicant: Brian O. Donahue, Allenspark, CO (US)

(72) Inventor: Brian O. Donahue, Allenspark, CO (US)

(21) Appl. No.: 14/738,954

(22) Filed: Jun. 15, 2015

(51) Int. Cl. B60L 7/16; B60L 11/18; B61C 7/04

(52) U.S. Cl. CPC B60L 7/16; B61C 7/04; B60L 11/1851; Y10S 903/905; Y10S 903/906; Y10S 903/907; Y10S 903/947

(57) ABSTRACT

The primary objective of the invention aims to capture electrical energy now lost as heat energy during dynamic braking of locomotive for reuse during upgrades and transfer to other locations with electrical energy demands.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The invention relates generally to energy management systems for use in connection with vehicles such as locomotives. In particular, the invention relates to a system for capturing reusing and transferring of electrical energy, such as dynamic braking energy to a variety of energy demands, further the invention converts a portion of Kinetic Energy into stored or transformed electrical energy which is reused by locomotives in pulling loads in opposite direction,

(2) Background of Invention

Locomotives used in present day railway systems often generate a great deal of heat energy which is not put to practical use. In locomotives equipped with dynamic braking there are some instances where special accommodations are provided to vent the generated heat to the atmosphere. For example, the electricity generated during dynamic braking of a diesel electric locomotive is generally passed through resistors and the heat generated by these resistors is vented to the atmosphere through the roof of the locomotive. Furthermore, a secondary heat contamination of the atmosphere is the heat generated by the diesel engine which is in direct proportion to work required and fuel consumption and accordingly the waste heat generated during the operation of the diesel engine of a diesel electric locomotive, including the waste heat carried off by the hot exhaust gases emitted by the diesel engine, is dissipated to the atmosphere.

Also, no energy recovery system has traditionally been available for capturing and storing the wasted heat energy generated during the operation of a diesel electric locomotive, far use at a remote location and at a later time.

Moreover, energy is dissipated by using the motors as generators loaded with dynamic brake grids. Grid (armature) current is determined by armature speed (locomotive) and by the amount of excitation applied to the motor fields. This proposal replaces the load created by dynamic brake grids excited by field current provided by main generator driven by locomotive diesel engines (at least a portion) with load created by battery banks. A reduction of load on dynamic brake grids would also reduce the occurrence of excessive dynamic braking current and possible equipment damage.

Further, dynamic braking is a system used to reduce locomotive speed but the invention converts a portion of Kinetic Energy into stored and transferred electrical energy which is reused by locomotives in pulling loads in opposite direction. The conversion of kinetic energy into electrical energy is accomplished by connecting a traction motor as generator with field current provided by the main generator, because the traction motor armatures are geared directly to the axles, the motor will rotate whenever the locomotive is moving. This proposal replaces, load created by dynamic brake grids excited by field current provided by main generator driven by locomotive diesel engines (at least a portion) with load created by battery banks.

Located on the control stand within the Indicating Light Panel is the BRAKE WARN light. The light has a push to test feature which allows testing of the lamp. When the lens cap is depressed the supply voltage is impressed across the lamp circuit and the light goes on. This light indicates excessive dynamic current. A reduction of load on dynamic brake grids would also reduce the occurrence of excessive dynamic braking current and possible equipment damage.

Taper and Flat are types of dynamic brake system, which is essential to maintain proper control of the braking system. In Taper system the amount of braking amperage developed with this system is controlled by the speed and the position of the dynamic braking controller. And in the flat system the amount of braking amperage developed with this system is controlled by the position of the dynamic braking controller only regardless of speed. However the greater the amperage production by the traction motors/generators, the greater the brake controller position the greater is the fuel consumption. Therefore the more amperage bled off the system into batteries or transformed to a different locomotive usage, the less amperage being wasted in dynamic braking the less would controller position the less would be fuel consumption.

Therefore, it is desirable to have a system that can reduce the wasted heat energy generated by a locomotive and reuse it as electrical energy. Also the system needs to be able to capture the electrical energy generated during dynamic braking for reuse and transfer rather than lose it to the atmosphere as wasted heat energy.

### BRIEF SUMMARY OF THE INVENTION

The primary objective of the invention aims to capture electrical energy now lost as heat energy during dynamic braking of locomotive for reuse during upgrades and transfer to other locations with electrical energy demands. Further according to the invention the EMD (Electro-Motive Diesel) units of dynamic braking engine speed is equipped with a two speed dynamic braking system and if the grid current is below 575 amperes these units maintain IDLE engine speed during dynamic brake operation and if the grid current exceeds 575 amperes the units would maintain a speed of RUN 4.

In one aspect, the GE (general electric) units is equipped with a modulated dynamic brake speed schedule according to the invention a RUN 8 engine speed will be maintained.

However, according to the invention if the GE (general electric) units are equipped with a modulated dynamic brake speed schedule, it allows the unit to operate in three different engine speeds. A IDLE engine speed will be maintained until the grid current is ranging approximately 0-460 amps, a RUN 4 engine speed will be maintained until the grid current is ranging approximately 460-610 amps and a RUN 8 engine speed will be maintained if the grid current is exceeds approximately 610 amps.

The present invention provides means for saving the fuel for rail road. Every unit of energy that is captured for reuse and transfer is a proportional amount of energy not required of the diesel engine(s) in a locomotive. This in turn is a proportional amount of fuel not required by the diesel engine. Also when adapted to traditional locomotives equipped with dynamic braking this approach could effectively turn all such locomotive into hybrids.

Further, the present invention is a means that can provide a supplementary energy for the energy demands at different locations.

Also the present invention has various battery banks internally and has smaller units that can be used for potential direct transfer.

The summary is provided to introduce a selection of concepts in a simplified form that are further described below in the detailed description. This Summary is not intended to identify key features or essential features of the subject matter, nor is it intended to be used as an aid in determining the scope of the subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an illustration of the usage of the invention.

FIG. 2 is diagrammatic representation of the concept of the invention.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments, but, on the contrary, the intention is to cover all modifications, equivalents, and alternatives falling within the spirit and scope of the present invention. The detailed descriptions below are designed to make such embodiments obvious to a person of ordinary skill in the art.

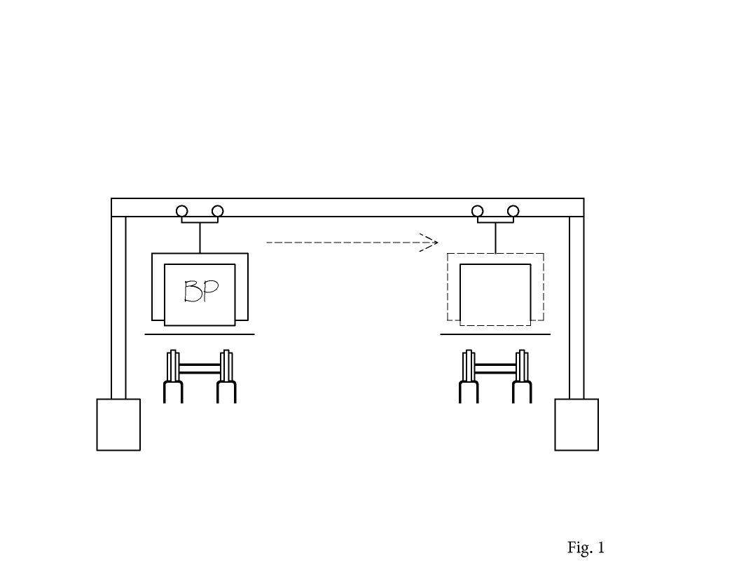

This invention as shown in FIG. 1 provides an improved means to capture electrical energy generated by dynamic braking thereby reducing energy lost as heat to the atmosphere through the dynamic braking grids as well as at the diesel engine and exhaust system.

According to the invention the dynamic braking engine speeds are, the EMD (Electro-Motive Diesel) units of dynamic braking engine speed is equipped with a two speed dynamic braking system and if the grid current is below 575 amperes these units maintain IDLE engine speed during dynamic brake operation and if the grid current exceeds 575 amperes the units would maintain a speed of RUN 4. In one aspect if the GE (general electric) units are equipped with a modulated dynamic brake speed schedule according to the invention, a RUN 8 engine speed will be maintained.

However, according to the invention if the GE (general electric) units are equipped with a modulated dynamic brake speed schedule, it allows the unit to operate in three different engine speeds. A IDLE engine speed will be maintained until the grid current is ranging approximately 0-460 amps, a RUN 4 engine speed will be maintained until the grid current is ranging approximately 460-610 amps and a RUN 8 engine speed will be maintained if the grid current is exceeds approximately 610 amps.

This invention provides supplementary electrical energy to the various energy demands of a diesel locomotive as well as a means of energy transfer to other locations.

This invention foresees the possibility of direct transfer of energy into rails, cables etc. allowing for smaller battery packs.

Further, the invention could be adapted to traditional locomotives equipped with dynamic breaking. This approach could effectively turn all such locomotives into hybrids. Hybrid locomotive are now braking the 500 ton/mile barrier increasing older ton/mile numbers by at least 10%

Furthermore, an auxiliary generator is also driven by a primary diesel engine in a locomotive. This auxiliary generator is used much like the alternators in an automobile. It is used for battery charging, lighting, energizing control circuits, actuating switch gear, etc. The electrical power demands on this generator could also be supplemented by the new method, electrical energy produced during dynamic braking mode. Every watt of supplemented energy from the new system means an equivalent amount of energy not required to be produced by the diesel engine.

In short this invention can be used everywhere dynamic braking is used and would allow transfer of captured energy to all points where energy is in demand. The method converts a portion of the kinetic energy into electrical energy and reverse by the locomotive pulling loads in opposite direction. Also the load created by dynamic break grids is replaced by load circuited to battery banks. Moreover the method reduces load on dynamic break grid which would also reduce the occurrence of excessive dynamic braking causing possible equipment damage.

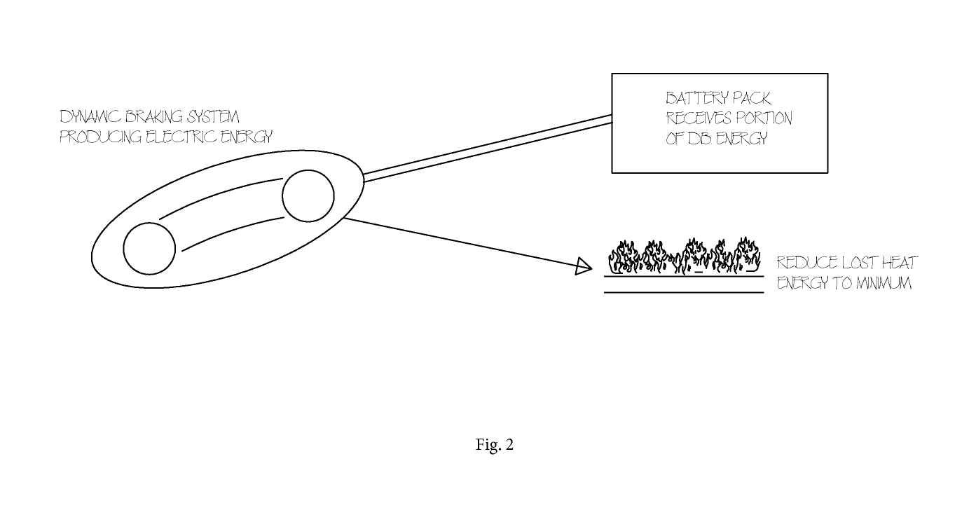

The battery banks could be dedicated to railcars or units designed for quick release and reattachment which would allow for rapid transfer between trains or other applications. Strategic transfer points could allow, as shown in FIG. 2, for battery banks to be transferred from train to train at normally schedule stops making more effective use of the charged battery packs.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I claim:

1. A method of managing energy generated in diesel engine(s) and providing alternative supplemental energy, comprising:
capturing every unit of electrical energy released as heat energy during dynamic braking of locomotive for reusing during upgrades; and
transferring to other locations with electrical energy demands said captured units of electrical energy.

2. The method of managing energy according to claim 1 wherein said energy generated by dynamic braking.

3. The method of managing energy according to claim 1 wherein said capturing providing reducing energy lost as heat to the atmosphere through the dynamic braking grids, the diesel engine, and exhaust system.

4. The method of managing energy according to claim 1, wherein said transferring of captured units of electrical energy is proportional to the amount of energy not required at the diesel engine(s).

5. The method of managing energy according to claim 1, wherein said supplementary electrical energy satisfying means of energy transfer to other locations.

6. The method of managing energy according to claim 1, wherein said supplementary electrical energy satisfying means of energy transfer to a diesel locomotive.

7. The method of managing energy according to claim 1 for providing a supplementary energy for the energy demands at different locations.

8. The method according to claim 1, wherein said capturing of electrical energy obtained at a plurality of battery banks.

9. The method according to claim 1, wherein said transferring obtained in smaller units for potential direct transfer.

10. The method according to claim 1, wherein said transferring is a direct transfer of energy into rails and cables allowing for smaller battery packs.
